(19) United States
(12) Patent Application Publication
(10) Pub. No.: US 2016/0258603 A1
(43) Pub. Date: Sep. 8, 2016

(54) LIGHTING DEVICE

(71) Applicant: PANASONIC INTELLECTUAL PROPERTY MANAGEMENT CO., LTD., Osaka (JP)

(72) Inventor: Ryoji YOKOTANI, Osaka (JP)

(73) Assignee: PANASONIC INTELLECTUAL PROPERTY MANAGEMENT CO., LTD., Osaka (JP)

(21) Appl. No.: 15/050,680

(22) Filed: Feb. 23, 2016

(30) Foreign Application Priority Data
Mar. 4, 2015 (JP) 2015-042958

(51) Int. Cl. F21V 19/02; F21K 99/00

(52) U.S. Cl. CPC F21V 19/02; F21K 9/56; F21Y 2101/02; F21Y 2105/003

(57) ABSTRACT

Lighting device includes: substrate having a major surface; light emitter which includes a first LED group mounted on the major surface, and a second LED group which is mounted on the major surface and surrounding the first LED group, light emission of the first LED group and light emission of the second LED group being controllable independently of each other; and lens disposed facing the major surface.

### CROSS REFERENCE TO RELATED APPLICATION

This application claims the benefit of priority of Japanese Patent Application Number 2015-042958, filed Mar. 4, 2015, the entire content of which is hereby incorporated by reference.

### BACKGROUND

1. Technical Field

The present disclosure relates to a lighting device.

2. Description of the Related Art

In recent years, LED lighting devices (e.g., see Japanese Unexamined Patent Application Publication No. 2013-206752) using LED light sources are becoming popular. Lighting devices which produce various types of light distribution are proposed, such as LED spotlights and LED universal downlights, for example.

### SUMMARY

A lighting device, which includes a light source and a lens and has a mechanism for changing the positional relationship between the light source and the lens, is known as a lighting device which allows a user to change the light emission pattern (light distribution). A drawback with such a lighting device is that the above mechanism increases the size of the lighting device.

The present disclosure provides a lighting device which allows a light emission pattern to be readily changed, without use of the above mechanism.

A lighting device according to one aspect of the present disclosure includes: a substrate having a major surface; a first light emitting element group mounted on the major surface, light emission of the first light emitting element group being controllable; a second light emitting element group mounted on the major surface and surrounding the first light emitting element group, light emission of the second light emitting element group being controllable independently of the light emission of the first light emitting element group; and a lens disposed facing the major surface.

According to the present disclosure, the light emission pattern can be readily changed.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is an external perspective view of a lighting device according to Embodiment 1.

FIG. 2 is a schematic cross-sectional view of the lighting device according to Embodiment 1.

FIG. 3A is a top view of a light emitting module.

FIG. 3B is a top view showing the arrangement of LEDs in the light emitting module (illustration of a sealing member shown in FIG. 3A is omitted).

FIG. 4A is a circuit diagram showing an example of a circuit structure of the light emitting module.

FIG. 4B is a first diagram showing another example of the circuit structure of the light emitting module.

FIG. 4C is a second diagram showing another example of the circuit structure of the light emitting module.

FIG. 5 is a top view of a light emitting module in which a plurality of LEDs are collectively sealed.

FIG. 6A is a top view of the light emitting module according to Variation of Embodiment 1.

FIG. 6B is a top view showing the arrangement of the LEDs in the light emitting module according to Variation (illustration of a sealing member shown in FIG. 6A is omitted).

FIG. 7 is a top view of a light emitting module according to Variation, in which a plurality of LEDs are collectively sealed.

### DETAILED DESCRIPTION OF EMBODIMENTS

Hereinafter, embodiments are described in detail, with reference to the accompanying drawings. Figures are schematic views and do not necessarily illustrate the present disclosure precisely.

The embodiments described below are each general and specific illustration. Values, shapes, materials, and components shown in the following embodiments are merely illustrative and not intended to limit the present disclosure. Among the components in the embodiments below, components not recited in any one of the independent claims indicating the top level concept of the present disclosure are described as arbitrary components.

The figures are schematic views and do not necessarily illustrate the present disclosure precisely. In the figures, the same reference signs are used to refer to substantially the same configuration, and thus duplicate description may be omitted or simplified.

### Embodiment 1

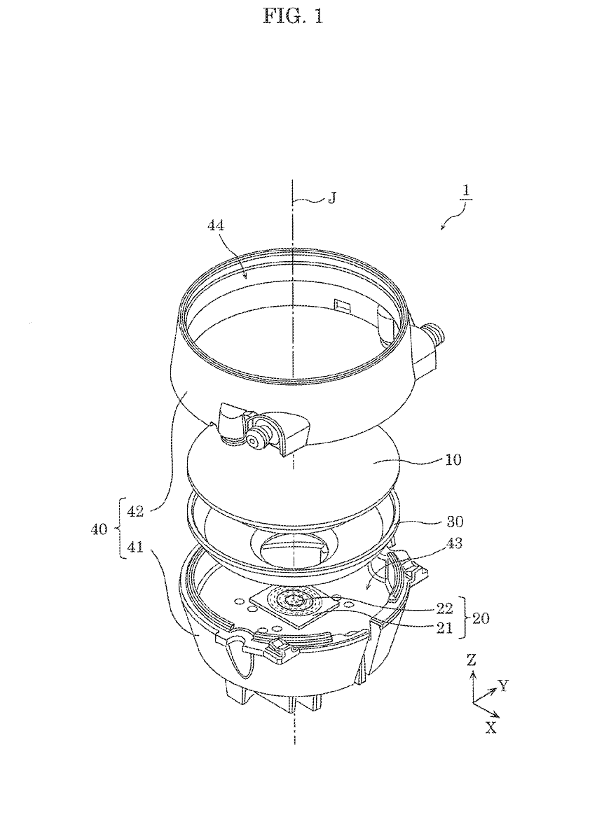

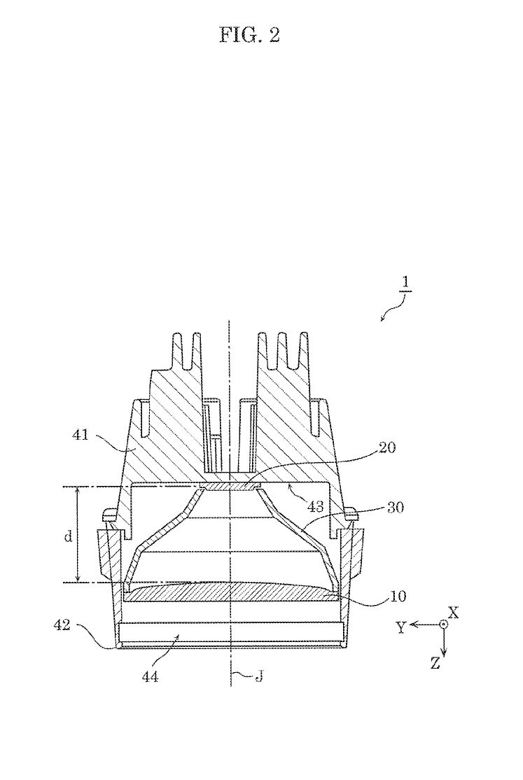

First, a configuration of a lighting device according to Embodiment 1 is described in detail. FIG. 1 is an external perspective view of the lighting device according to Embodiment 1. FIG. 2 is a schematic cross-sectional view of the lighting device according to Embodiment 1.

Lighting device 1 shown in FIGS. 1 and 2 is a lighting device used as a spotlight or a downlight, for example. Lighting device 1 includes lens 10, light emitting module 20 (substrate 21 and light emitter 22), reflector 30, and housing 40 (first housing 41 and second housing 42).

FIGS. 1 and 2 also show lamp axis J (hereinafter, also, simply referred to as axis J.) of lighting device 1. Axis J is the central axis of lighting device 1 and coincides with the optical axis of lens 10 and the optical axis of light emitter 22.

In FIGS. 1 and 2, Z-axis direction is the vertical direction, for example. The positive Z axis side may also be referred to as a light-exiting side. The negative Z axis side may also be referred to as an installation surface side. X-axis direction and Y-axis direction are orthogonal to each other on a plane (a horizontal plane) perpendicular to Z axis. In the following, components included in lighting device 1 are described.

Light emitting module 20 is a light source (a light emitting device) which emits white light, and includes substrate 21 having a major surface (hereinafter, also referred to as a first major surface) and light emitter 22 disposed on the first major surface of substrate 21. Light emitting module 20 is mounted on first housing 41 so that a major surface of substrate 21 (hereinafter, also referred to as a second major surface) opposite the first major surface is in surface contact with placement surface 43 of first housing 41. Details of the configuration of light emitting module 20 are described below.

Reflector 30 is a reflective member having reflection functionality. Reflector 30 is disposed between light emitting module 20 and lens 10 and has an entrance through which light from light emitting module 20 enters and an exit through which the light is sent to lens 10. Reflector 30 is in an annular cylindrical shape (a funnel shape) the internal diameter of which gradually increases from the entrance toward the exit. The inner peripheral surface of reflector 30 serves as a reflective surface which reflects the light entered through the entrance and sends it out through the exit.

Reflector 30 is formed of, for example, a rigid white resin material such as polybutylene terephthalate (PBT), but may be formed of a highly reflective metallic material such as aluminum. Alternatively, reflector 30 may be formed of resin, and a metalized membrane (a metal reflective coating) comprising a metallic material such as silver and aluminum may be formed on the inner peripheral surface.

Lens 10 is an optical member for imparting a predetermined (predesigned) light distribution property to lighting device 1, and disposed facing the first major surface of substrate 21 (light emitter 22). Lens 10 is, specifically, a convex lens which is disposed so that an entry surface of lens 10 faces light emitter 22, and diffuses light (the light sent out from the exit of reflector 30) entered the entry surface and sends it out through an exit surface. It should be noted that lens 10 may be a Fresnel lens.

Lens 10 is disposed in a manner that the optical axis of lens 10 coincides with the optical axis of light emitter 22. Distance d between lens 10 and the major surface of substrate 21 is less than or equal to a focal length of lens 10.

The shape in plan of lens 10 (a shape when viewed from the direction of axis J) is a round shape the diameter of which is greater than the diameter of light emitter 22. Light emitter 22 is covered with lens 10 when viewed from the direction of axis J.

Lens 10 is secured to second housing 42 so as to cover, from the interior side of second housing 42, light exit 44 (a main opening) formed in second housing 42. Lens 10 is formed of, for example, a transparent resin material (a light-transmissive resin material) such as PMMA (acrylic) and polycarbonate, but may be formed of a transparent material such as a glass material.

Housing 40 houses light emitting module 20 (substrate 21), reflector 30, and lens 10. Housing 40 includes first housing 41 and second housing 42.

First housing 41 is a portion of housing 40 to the installation surface side, and serves as a mounting base on which light emitting module 20 is mounted. First housing 41 is in a generally frustoconical shape the diameter of which gradually increases from the installation surface side (the negative Z axis side) toward the light-exiting side (the positive Z axis side). First housing 41 has placement surface 43 on which light emitting module 20 is mounted in a manner that the second major surface of light emitting module 20 is in surface contact with placement surface 43.

First housing 41 serves also as a heat sink which dissipates heat generated by light emitting module 20. First housing 41 is formed of, for example, a metallic material such as aluminum die casting, but may be formed of any other material. It should be noted that a heat dissipation member (such as a heat dissipation sheet or thermal grease) may be disposed between placement surface 43 and light emitting module 20.

Second housing 42 is a portion of housing 40 to the light-exiting side. Second housing 42 has light exit 44. Second housing 42 is in a generally circular cylindrical shape the internal diameter of which gradually increases from the installation surface side (the negative Z axis side) toward the light-exiting side (the positive Z axis side). As second housing 42 is mounted onto first housing 41, lens 10 and reflector 30 are secured. Second housing 42 is formed of, for example, a metallic material such as such as aluminum die casting, but may be formed of any other material.

[Configuration of Light Emitting Module]

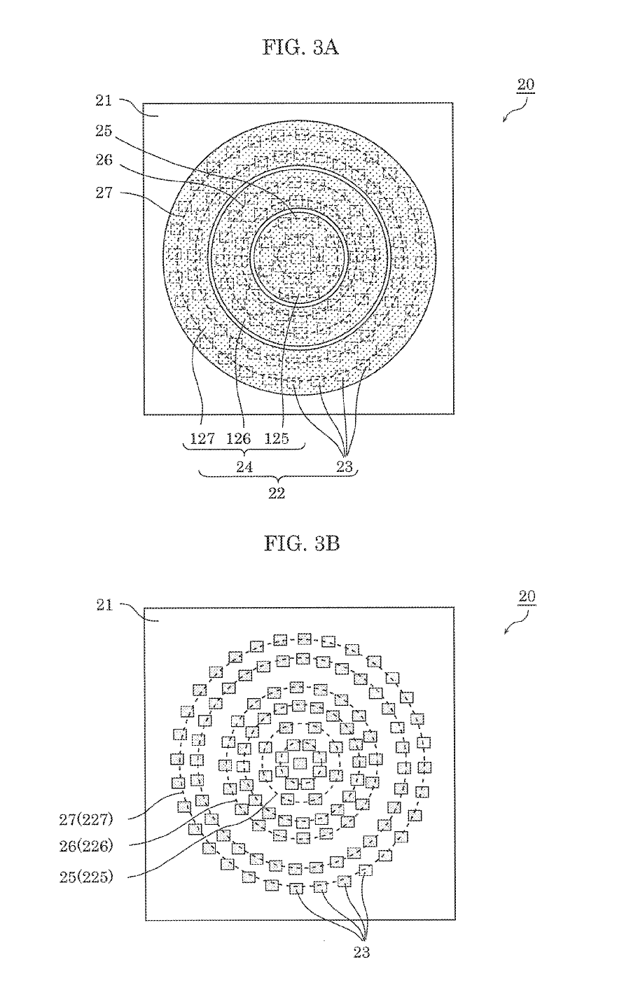

Next, a configuration of light emitting module 20 is to be described. FIG. 3A is a top view of light emitting module 20. FIG. 3B is a top view showing the arrangement of LEDs in light emitting module 20 (the illustration of the sealing member shown in FIG. 3A is omitted).

As shown in FIG. 3A, light emitting module 20 includes substrate 21 having the first major surface, and light emitter 22 disposed on the first major surface. Light emitter 22, specifically, includes a plurality of LEDs 23 mounted on the first major surface of substrate 21, and sealing member 24 (first sealing member 125, second sealing member 126, and third sealing member 127) which seals the plurality of LEDs 23.

Substrate 21 is a plate-like member in a rectangular form in plan view, and the plurality of LEDs 23 are mounted thereon. Substrate 21 is, specifically, a ceramic substrate, a resin substrate, or a metal base substrate which has undergone insulation coating using white resist, for example. It should be noted that, although not shown, on substrate 21, an interconnection pattern for supplying LEDs 23 with power, and a pair of electrode terminals (a positive electrode terminal and a negative electrode terminal) which externally receives power for causing LEDs 23 to emit light are formed.

LEDs 23 are each by way of example of a light emitting element. Specifically, LED 23 is, for example, a gallium nitride-based semiconductor light-emitting element comprising an InGaN-based material and having a center wavelength (a peak wavelength of emission spectrum) of 430 nm or greater and 500 nm or less and. In other words, LEDs 23 are blue LEDs which emit blue light. It should be noted that the method of mounting LEDs 23 on substrate 21 is not particularly limited. LEDs 23 may be flip chipped onto (mounted face down on) substrate 21, or may be mounted face up on substrate 21.

Sealing member 24 is a resin member (a resin material) containing phosphor and seals the plurality of LEDs 23 on the first major surface of substrate 21. Sealing member 24, specifically, comprises a light-transmissive resin material, such as silicone resin containing yellow phosphor. The light-transmissive resin material is, for example, a silicone resin. The yellow phosphor particles are, for example, yttrium aluminum garnet (YAG)-based yellow phosphor particles.

In such a light emitting module 20, a portion of the blue light emitted by LEDs 23 excites the phosphor included in sealing member 24, in response to which the phosphor emits yellow phosphor light. Then, the blue light emitted by LEDs 23 and the yellow phosphor light emitted by the excited phosphor are mixed, thereby producing white light. It should be noted that a color temperature of the white light produced by light emitting module 20 depends on a ratio between an amount of blue light emitted by LEDs 23 and an amount of yellow phosphor light emitted by the phosphor.

[Arrangement of LEDs and Circuit Structure]

In light emitting module 20, the plurality of LEDs 23 are disposed concentrically. In the embodiment below, a plurality of LEDs 23 disposed along one circle are referred to as one LED group.

For example, as shown in FIG. 3B, on substrate 21, first LED group 25 consisting of a plurality of LEDs 23 is disposed in a ring form along first circle 225, and second LED group 26 consisting of a plurality of LEDs 23 is disposed in a ring form along second circle 226. On substrate 21, third LED group 27 consisting of a plurality of LEDs 23 is also disposed in a ring form along third circle 227. First LED group 25, second LED group 26, and third LED group 27 are sealed by sealing member 24, thereby forming light emitter 22.

First circle 225, second circle 226, and third circle 227 are concentric circles. First LED group 25 is by way of example of a first light emitting element group. Second LED group 26 is by way of example of a second light emitting element group. Third LED group 27 is by way of example of a third light emitting element group.

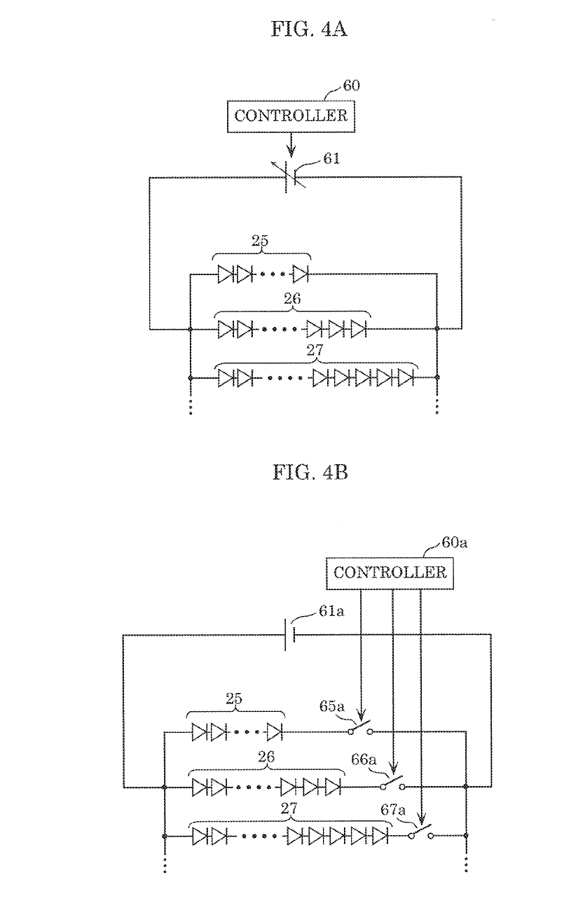

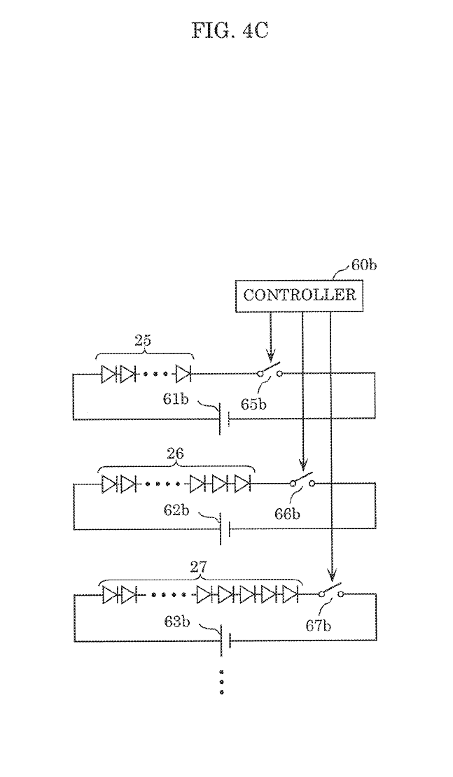

A plurality of LED groups, including first LED group 25, second LED group 26, and third LED group 27, are electrically connected to one another in a manner that the light emission of the individual LED groups is controllable independently of one another. FIG. 4A is a circuit diagram showing an example of a circuit structure of light emitting module 20. It should be noted that illustration of the LED groups, other than first LED group 25, second LED group 26, and third LED group 27, are omitted in FIG. 4A.

In FIG. 4A, controller 60, including variable power supply 61, is also shown. Controller 60 controls the light emission of first LED group 25, second LED group 26, and third LED group 27.

As shown in FIGS. 3B and 4A, the more outwardly the LED group is located, the greater the number of LEDs 23 the LED group includes. For example, the number of LEDs 23 (hereinafter, referred to as n1) included in first LED group 25 is less than the number of LEDs 23 (hereinafter, referred to as n2) included in second LED group 26. Likewise, the number n2 of LEDs 23 included in second LED group 26 is less than the number of LEDs 23 (hereinafter, referred to as n3) included in third LED group 27.

The plurality of LEDs 23 per LED group are connected in series. For example, the plurality of LEDs 23 included in first LED group 25 are connected in series, and the plurality of LEDs 23 included in second LED group 26 are connected in series. Likewise, the plurality of LEDs 23 included in third LED group 27 are connected in series.

One LED group and another LED group are connected in parallel. Specifically, first LED group 25, second LED group 26, and third LED group 27 are connected in parallel.

In such a circuit structure, controller 60 controls a voltage of variable power supply 61, thereby causing the plurality of LED groups to emit light one group after another, starting from the innermost LED group.

As described above, in light emitting module 20, the more outwardly the LED group is located, the greater the number of LEDs 23 the LEI) group includes. Thus, the more outwardly the LED group is located, the greater the voltage the LED group uses to initiate the light emission.

For example, to cause first LED group 25 to emit light, an output voltage of variable power supply 61 needs to be Vf×n1 or greater, where Vf represents a forward voltage of LEDs 23. Likewise, to cause second LED group 26 to emit light, the output voltage of variable power supply 61 needs to be Vf×n2 (>n1) or greater, and to cause third LED group 27 to emit light, the output voltage of variable power supply 61 needs to be Vf×n3 (>n2) or greater.

Thus, as controller 60 gradually increases the output voltage of variable power supply 61 from 0 V, the emission area of light emitter 22 gradually increases from its center. In other words, a light emission pattern (a state of illumination on an object having the light emitted thereto) produced by lighting device 1 is changeable by adjusting the output voltage of variable power supply 61, which obviates the need for a special mechanism or the like. Lighting device 1 allows the light emission pattern to be readily changed in such a manner.

It should be noted that in the circuit structure of FIG. 4A, when one LED group emits light, all LEDs 23 located inwardly of the one LED group emit light. Specifically, while controller 60 is causing second LED group 26 to emit light, controller 60 is also causing first LED group 25 to emit light. Here, if an outline of light emitter 22 when viewed in plan is identical with the outline of lens 10, light distribution close to Lambertian is obtained when all the LED groups are emitting light.

It should be noted that the circuit structure of FIG. 4A is one example and any other circuit structure may be employed insofar as it at least can control the light emission (on and of) of individual LED groups independently of one another. FIGS. 4B and 4C are diagrams showing other examples of the circuit structure.

For example, as shown in FIG. 4B, one switch may be provided per LED group, and the power supply from power source 61a to the LED group may be controlled by turning the switch on and off. In the example of FIG. 4B, specifically, controller 60a turns switch 65a on and thereby supplies first LED group 25 with power from power source 61a and causes first LED group 25 to emit light, and turns switch 66a on and thereby supplies second LED group 26 with power from power source 61a and causes second LED group 26 to emit light. Likewise, controller 60a turns switch 67a on and thereby supplies third LED group 27 with power from power source 61a and causes third LED group 27 to emit light.

Alternatively, as shown in FIG. 4C, one power source and one switch may be provided per LED group. In the example of FIG. 4C, controller 60b turns switch 65b on and thereby supplies first LED group 25 with power from power source 61b and causes first LED group 25 to emit light, and turns switch 66b on and thereby supplies second LED group 26 with power from power source 62b and causes second LED group 26 to emit light. Likewise, controller 60b turns switch 67b on and thereby supplies third LED group 27 with power from power source 63b and causes third LED group 27 to emit light.

As described above, lighting device 1 includes substrate 21 having the first major surface, first LED group 25 mounted on the first major surface, second LED group 26 mounted on the first major surface, which is surrounding first LED group 25, and the light emission thereof is controllable independently of first LED group 25, and lens 10 disposed facing the first major surface. The “light emission thereof is controllable independently of first LED group 25” as used herein refers to allowing the control of turning on and off of second LED group 26 only, while maintaining a light emitting state (either one of the on-state and the off-state) of at least first LED group 25.

Such a lighting device 1 allows a light emission pattern to be readily changed by selectively causing the LED groups to emit light. Lighting device 1 requires no mechanism for changing the positional relationship between the LED groups and lens 10. Thus, lighting device 1 can readily be scaled to a small size and implemented at low cost.

In addition, an emission pattern of a conventional lighting device tends to have high intensity near the center and low intensity in the peripheral portion. In other words, the conventional lighting device tends to produce an emission pattern having non-uniform illuminance distribution. In contrast, lighting device 1 can bring the illuminance distribution of the emission pattern to uniform by setting the emission luminance of first LED group 25 dimmer than the emission luminance of second LED group 26.

For example, lighting device 1 can set the emission luminance of first LED group 25 dimmer than the emission luminance of second LED group 26 by controlling currents supplied to the respective LED groups. Also for example, first LED group 25 may employ LEDs (LEDs which dim if the current values supplied are the same) that have lower emission luminance than LEDs 23 included in second LED group 26.

It should be noted that a specific aspect for implementing the circuit structure as described above (the circuit for supplying power to each LED group) is not particularly limited. For example, the interconnection pattern provided on substrate 21 may electrically connect the plurality of LEDs 23, or Chip to Chip interconnection by bonding wires may electrically connect the plurality of LEDs 23. Alternatively, the electrical connection of the plurality of LEDs 23 may be established by a combination of the interconnection pattern and the bonding wires.

Moreover, controllers 60, 60a, and 60b may be implemented as dedicated circuits, or may be implemented as microcomputers or processors. Controllers 60, 60a, and 60b may also be implemented by arbitrary combining dedicated circuits, microcomputers, and processors. It should be noted that controllers 60, 60a, and 60b selectively cause the plurality of LED groups to emit light, according to user operation of a remote control, for example.

[Configuration of Sealing Member]

As shown in FIG. 3A, in light emitting module 20, first sealing member 125 sealing first LED group 25 and second sealing member 126 sealing second LED group 26 are disposed spaced apart from each other. Likewise, second sealing member 126 sealing second LED group 26 and third sealing member 127 sealing third LED group 27 are disposed spaced apart from each other. Specifically, a portion of the major surface of substrate 21 is externally exposed between first sealing member 125 and second sealing member 126 and between second sealing member 126 and third sealing member 127. In the following, advantageous effects obtained from such a configuration are described.

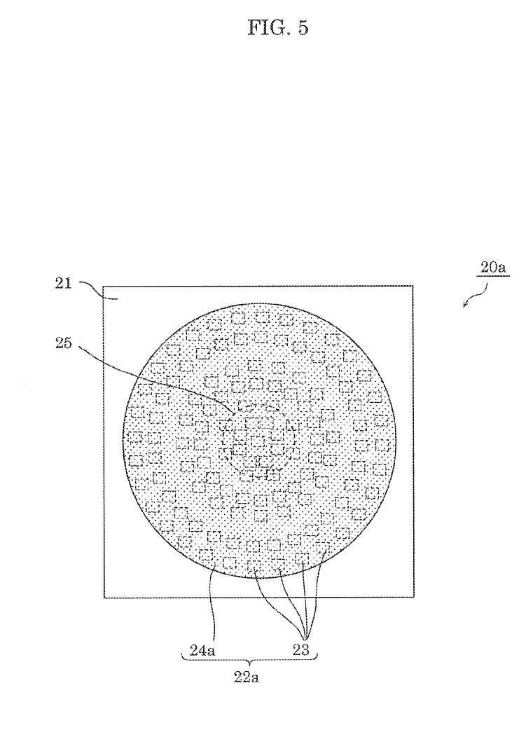

The plurality of LEDs 23 arranged as shown in FIG. 3B may be sealed tight from the center of light emitter 22a to the outer edge by sealing member 24a, as light emitter 22a of light emitting module 20a shown in FIG. 5. FIG. 5 is a top view of light emitting module 20a in which the plurality of LEDs 23 are collectively sealed.

Here, for example, if a lighting device which includes light emitting module 20a causes LEDs 23 included in first LED group 25 and LEDs 23 located inwardly of first LED group 25 to emit light, among the plurality of LEDs 23 included in light emitter 22a, a portion of sealing member 24a located slightly outside of first LED group 25 also ends up emitting yellow light. Thus, the contour of a pattern of the light emitted by the lighting device in which light emitting module 20a are included may be blurred. In addition, the contour portion of the pattern of light emitted by the lighting device in which light emitting module 20a are included may end up having an emission color of a different hue.

In light emitting module 20, in contrast, first sealing member 125 and second sealing member 126 are disposed spaced apart from each other. In other words, no sealing member (phosphor) is disposed between first sealing member 125 and second sealing member 126. This can reduce the blur in the contour portion of the emission pattern, defining the contour of the emission pattern. This can also prevents the hue of the emission color in the contour portion of the emission pattern from becoming yellower than the emission color around the center of the emission pattern.

For the same reason, the pattern of the light emitted by lighting device 1 may also end up having a yellow contour portion, causing emission light to have non-uniform color temperature distribution. In such a case, the concentration of the yellow phosphor may be adjusted so that the more outwardly the sealing member is located, the lower concentration the yellow phosphor contained in the sealing member has.

Specifically, the concentration of the yellow phosphor may be adjusted so that the concentration of the yellow phosphor contained in second sealing member 126 is lower than the concentration of the yellow phosphor contained in first sealing member 125, and the concentration of the yellow phosphor contained in third sealing member 127 is lower than the concentration of the yellow phosphor contained in second sealing member 126. In other words, a color temperature of the light emitted by first sealing member 125 may be set lower than a color temperature of the light emitted by second sealing member 126 and the color temperature of the light emitted by second sealing member 126 may be set lower than a color temperature of the light emitted by third sealing member 127. This can achieve an emission pattern that has uniform color temperature distribution.

[Variation]

While in the above embodiment, one LED group includes LEDs 23 disposed in a ring shape, the light emitting module included in lighting device 1 may at least include LED groups one of which is surrounding another and light emission of one LED group is controllable independently of another LED group. Thus, the arrangement of LEDs 23 is not limited to the arrangement of light emitting module 20 and 20a and may be any other arrangement.

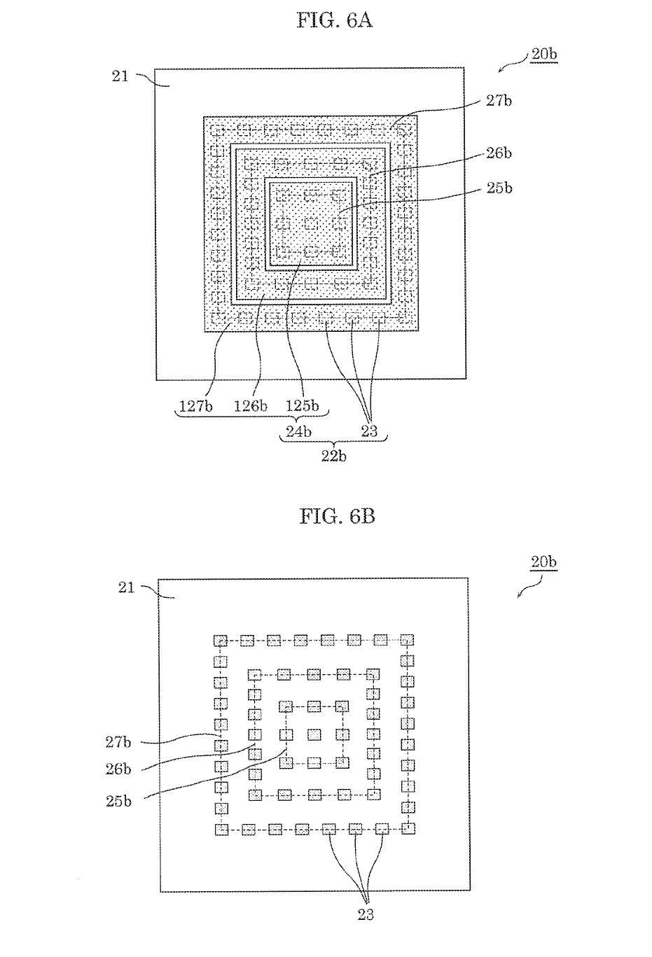

For example, the LED groups each may be arranged in a rectangular ring form in plan view (hereinafter, simply referred to as a rectangular ring form). FIG. 6A is a top view of the light emitting module in which the LED groups are each disposed in a rectangular ring form. FIG. 6B is a top view showing the arrangement of the LEDs on the light emitting module in FIG. 6A (illustration of the sealing member in FIG. 6A is omitted).

As shown in FIG. 6A, light emitting module 20b includes substrate 21 having a first major surface, and light emitter 22b disposed on the first major surface. Light emitter 22b, specifically, includes the plurality of LEDs 23 mounted on the first major surface of substrate 21, and sealing member 24b (first sealing member 125b, second sealing member 126b, and, third sealing member 127b) which seals the plurality of LEDs 23. Sealing member 24b is a resin member which contains phosphor and seals the plurality of LEDs 23 on the first major surface of substrate 21.

In light emitting module 20b shown in FIGS. 6A and 6B, the plurality of LEDs 23 are disposed in concentric rectangle forms (rectangle forms in which respective positions of the center of gravity are the same).

For example, as shown in FIG. 6B, on substrate 21, first LED group 25b consisting of a plurality of LEDs 23 is disposed in a rectangular ring form, second LED group 26b consisting of a plurality of LEDs 23 is disposed in a rectangular ring form surrounding first LED group 25b. On substrate 21, third LED group 27b consisting of a plurality of LEDs 23 is also disposed in a rectangular ring form surrounding second LED group 26b. First LED group 25b is by way of example of the first light emitting element group. Second LED group 26b is by way of example of the second light emitting element group. Third LED group 27b is by way of example of the third light emitting element group.

First LED group 25b, second LED group 26b, and, third LED group 27b are electrically connected to one another in a manner that light emission of the individual LED groups is controllable independently of one another. It should be noted that a specific circuit structure in this case is, for example, the same as the circuit structure described with reference to FIGS. 4A through 4C.

A lighting device which includes such a light emitting module 20b also allows a light emission pattern to be readily changed by selectively causing the LED groups to emit light.

As shown in FIG. 6A, in light emitting module 20b, first sealing member 125b sealing first LED group 25b and second sealing member 126b sealing second LED group 26b are disposed spaced apart from each other. Likewise, second sealing member 126b sealing second LED group 26b and third sealing member 127b sealing third LED group 27 are disposed spaced apart from each other.

This allows the lighting device which includes light emitting module 20b to reduce blur in a contour portion of the emission pattern, defining the contour of the emission pattern, as with lighting device 1.

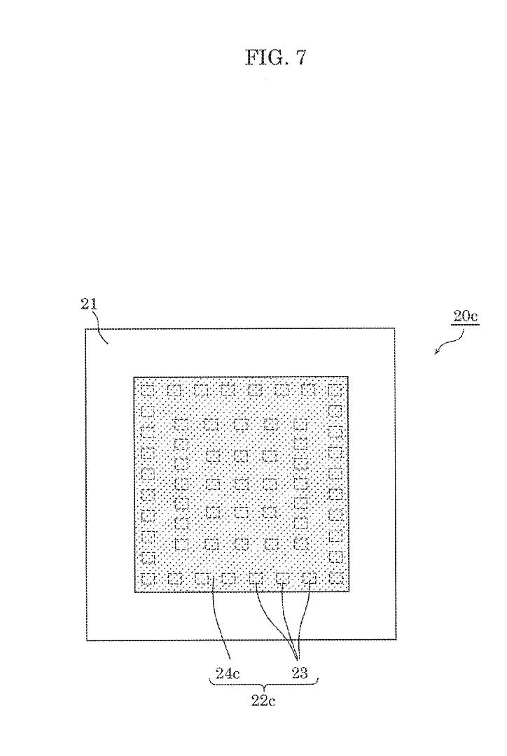

It should be noted that the plurality of LEDs 23 arranged as shown in FIG. 6B may be sealed tight from the center of light emitter 22c to the outer edge by sealing member 24c, as light emitter 22c of light emitting module 20c shown in FIG. 7. FIG. 7 is a top view of light emitting module 20c in which a plurality of LEDs are collectively sealed.

### Other Embodiments

While the lighting device according to the embodiment has been described above, the present disclosure is not limited to the embodiment.

For example, while the above embodiment has been described with reference to the lighting device implemented as a spotlight or a downlight, the present disclosure is also applicable to any other lighting devices such as ceiling lights. The present disclosure is also applicable to lighting devices (illumination light sources) such as bulb lamps.

Moreover, the lighting device according to the above embodiment includes the COB (Chip On Board) light emitting module, an SMD (surface mount device) light emitting module on which surface-mounted LED elements (one example of the light emitting element) are mounted may be used. The surface-mounted LED element is a packaged LED element in which an LED chip is mounted inside a resin-molded cavity and the cavity is sealed with a sealing member (phosphor-containing resin).

The SMD light emitting module can also bring illuminance distribution of the emission pattern to uniform by setting the emission luminance of a first LED element group dimmer than the emission luminance of a second LED element group surrounding the first LED element group. In addition, an emission pattern that has uniform color temperature distribution can be achieved by setting a color temperature of the first LED element group lower than a color temperature of the second LED element group surrounding the first LED element group.

Moreover, while the light emitting module according to the above embodiment is configured to produce white light, using blue LEDs and yellow phosphor, the light emitting module is not limited to such a configuration. For example, the light emitting module may be configured to produce white light by a combination of blue LEDs and a sealing member containing red phosphor and green phosphor in addition to yellow phosphor. Also for example, the light emitting module may be configured to produce white light by a combination of the blue LEDs and a sealing member containing red phosphor and green phosphor, instead of yellow phosphor.

Moreover, while LEDs according to the above embodiment have been described to be blue LEDs, LEDs which emit light that have colors other than blue may be used. For example, LEDs which emit ultraviolet may be used. In this case, the phosphor used may be, for example, a combination of phosphors which respectively emit the primary colors (red, green, blue).

Moreover, the light emitting module may include, rather than the LEDs, semiconductor light emitting elements such as a semiconductor laser, or any other type of solid-state light emitting element, such as an organic electro luminescent (EL) element or inorganic EL element, for example.

Moreover, the above embodiment has been described with reference to the light emitting module which produces white light, the emission color of the light emitting module is not particularly limited.

Moreover, the controller according to the embodiment may be configured with dedicated hardware or may be implemented by executing a software program suitable for the controller. The controller may also be implemented by a program execution unit, such as a CPU or processor, loading and executing the software program stored in a recording medium such as a hard disk or a semiconductor memory.

While the lighting device according to one or more aspects of the present disclosure has been described with reference to the embodiments, the present disclosure is not limited to the embodiments. Various modifications to the embodiments that may be conceived by a person skilled in the art or combinations of the components of different embodiments are intended to be included within the scope of the one or more aspects of the present disclosure, without departing from the spirit of the present disclosure.

For example, the present disclosure may be implemented as the light emitting module (the light emitting device) according to the above embodiments.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. Alighting device comprising:
a substrate having a major surface;
a first light emitting element group mounted on the major surface, light emission of the first light emitting element group being controllable;
a second light emitting element group mounted on the major surface and surrounding the first light emitting element group, light emission of the second light emitting element group being controllable independently of the light emission of the first light emitting element group; and
a lens disposed facing the major surface.

2. The lighting device according to claim 1, wherein
the first light emitting element group is disposed along a first circle, and
the second light emitting element group is disposed along a second circle surrounding the first circle and concentric with the first circle.

3. The lighting device according to claim 1, further comprising
a sealing member containing phosphor, which seals the first light emitting element group and the second light emitting element group.

4. The lighting device according to claim 3, wherein
the sealing member includes:
a first sealing member which seals the first light emitting element group; and
a second sealing member which seals the second light emitting element group, disposed spaced apart from the first sealing member.

5. The lighting device according to claim 4, wherein
a concentration of phosphor contained in the first sealing member is higher than a concentration of phosphor contained in the second sealing member.

6. The lighting device according to claim 4, wherein
a color temperature of light emitted by the first sealing member is lower than a color temperature of light emitted by the second sealing member.

7. The lighting device according to claim 1, wherein
emission luminance of the first light emitting element group is dimmer than emission luminance of the second light emitting element group.

8. The lighting device according to claim 1, wherein
a total number of light emitting elements included in the first light emitting element group is less than a total number of light emitting elements included in the second light emitting element group,
the light emitting elements included in the first light emitting element group are connected in series,
the light emitting elements included in the second light emitting element group are connected in series, and
the first light emitting element group and the second light emitting element group are connected in parallel.

9. The lighting device according to claim 1, wherein
the first light emitting element group and the second light emitting element group form a light emitter, and
the lens is disposed in a manner that an optical axis of the lens coincides with an optical axis of the light emitter.

10. The lighting device according to claim 1, wherein
a distance between the lens and the major surface is less than or equal to a focal length of the lens.

11. The lighting device according to claim 1, further comprising
a housing which houses the substrate and the lens.

12. The lighting device according to claim 1, further comprising
a controller which controls light emission of the first light emitting element group and light emission of the second light emitting element group, wherein
the controller causes the first light emitting element group to emit light while causing the second light emitting element group to emit light.
